(19) United States
(12) Patent Application Publication
(10) Pub. No.: US 2013/0149023 A1
(43) Pub. Date: Jun. 13, 2013

(54) ADJUSTABLE CLEVIS ASSEMBLY

(71) Applicants: Stanley Wiecko, Newington, CT (US); Bernard W. Pudvah, Middletown, CT (US); Eugene C. Gasmen, Rocky Hill, CT (US)

(72) Inventors: Stanley Wiecko, Newington, CT (US); Bernard W. Pudvah, Middletown, CT (US); Eugene C. Gasmen, Rocky Hill, CT (US)

(73) Assignee: UNITED TECHNOLOGIES CORPORATION, East Hartford, CT (US)

(21) Appl. No.: 13/316,082

(22) Filed: Dec. 9, 2011

(51) Int. Cl. F16C 11/04

(52) U.S. Cl. 403/79

(57) ABSTRACT

An adjustable clevis assembly includes a clevis, a first adjustment sleeve, a second adjustment sleeve, a tongue and a clevis pin. The clevis includes a first support flange with a first sleeve aperture and a second support flange with a second sleeve aperture. The first adjustment sleeve is seated in the first sleeve aperture, and includes a first pin aperture that is eccentric relative to the first sleeve aperture. The second adjustment sleeve is seated in the second sleeve aperture, and includes a second pin aperture that is eccentric relative to the second sleeve aperture. The tongue is arranged between the first support flange and the second support flange. The clevis pin extends through the first pin aperture, the second pin aperture and a third pin aperture in the tongue.

### BACKGROUND OF THE INVENTION

1. Technical Field

The present invention relates generally to clevis assemblies and, in particular, to an adjustable clevis assembly that may be utilized, for example, in a bell crank system for a gas turbine engine.

2. Background Information

A gas turbine engine may include a bell crank system to actuate a mechanical engine control system such as, for example, a compressor bypass valve, an adjustable stator vane, etc. Such a bell crank system may include a clevis assembly that connects a tie rod to a bell crank body. The clevis assembly may be connected to the bell crank body with a bolt and nut. The aim length of the clevis assembly may be adjusted by arranging one or more shims between the clevis assembly and the bell crank body. Implementing such an adjustment, however, may require disassembling the bell crank system in order to position the shims onto the bolt between the clevis assembly and the bell crank body.

### SUMMARY OF THE DISCLOSURE

According to a first aspect of the invention, an adjustable clevis assembly includes a clevis having a first support flange extending from a base segment, a second support flange extending from the base segment, a first sleeve aperture extending through the first support flange, and a second sleeve aperture extending through the second support flange. The adjustable clevis assembly also includes a first adjustment sleeve seated in the first sleeve aperture, a second adjustment sleeve seated in the second sleeve aperture, a tongue arranged between the first support flange and the second support flange, and a clevis pin. The first adjustment sleeve has a first pin aperture that extends therethrough and that is eccentric relative to the first sleeve aperture. The second adjustment sleeve has a second pin aperture that extends therethrough and that is eccentric relative to the second sleeve aperture. The clevis pin extends through the first pin aperture, the second pin aperture and a third pin aperture in the tongue.

According to a second aspect of the invention, an adjustable bell crank system includes a bell crank having a first support flange extending from a bell crank base segment, a second support flange extending from the bell crank base segment, a first sleeve aperture extending through the first support flange along a first axis, and a second sleeve aperture extending through the second support flange along the first axis. The adjustable bell crank system also includes a first adjustment sleeve mated with the first sleeve aperture, a second adjustment sleeve mated with the second sleeve aperture, a tie rod tongue arranged between the first support flange and the second support flange, and a clevis pin. The first adjustment sleeve includes a first pin aperture that extends therethrough along a second axis, where the first pin aperture is eccentric relative to the first sleeve aperture. The second adjustment sleeve includes a second pin aperture that extends therethrough along the second axis. The clevis pin extends through the first pin aperture, the second pin aperture and a third pin aperture in the tie rod tongue.

The foregoing features and the operation of the invention will become more apparent in light of the following description and the accompanying drawings.

### BRIEF DESCRIPTION OF THE DRAWINGS

FIG. 1 is a perspective illustration of an adjustable bell crank system for a gas turbine engine;

FIG. 2 is a sectional perspective illustration of an adjustable clevis assembly included in the bell crank system;

FIG. 3 is an illustration of a first adjustment sleeve included in the adjustable clevis assembly;

FIG. 4 is a cross-sectional illustration of the first adjustment sleeve illustrated in FIG. 3;

FIG. 5 is an illustration of a second adjustment sleeve included in the adjustable clevis assembly;

FIG. 6 is a cross-sectional illustration of the second adjustment sleeve illustrated in FIG. 5;

FIG. 7 is a perspective illustration of a clevis pin and a tab washer included in the adjustable clevis assembly;

FIG. 8 is an illustration of the bell crank system in a first configuration; and

FIG. 9 is an illustration of the bell crank system in a second configuration.

### DETAILED DESCRIPTION OF THE INVENTION

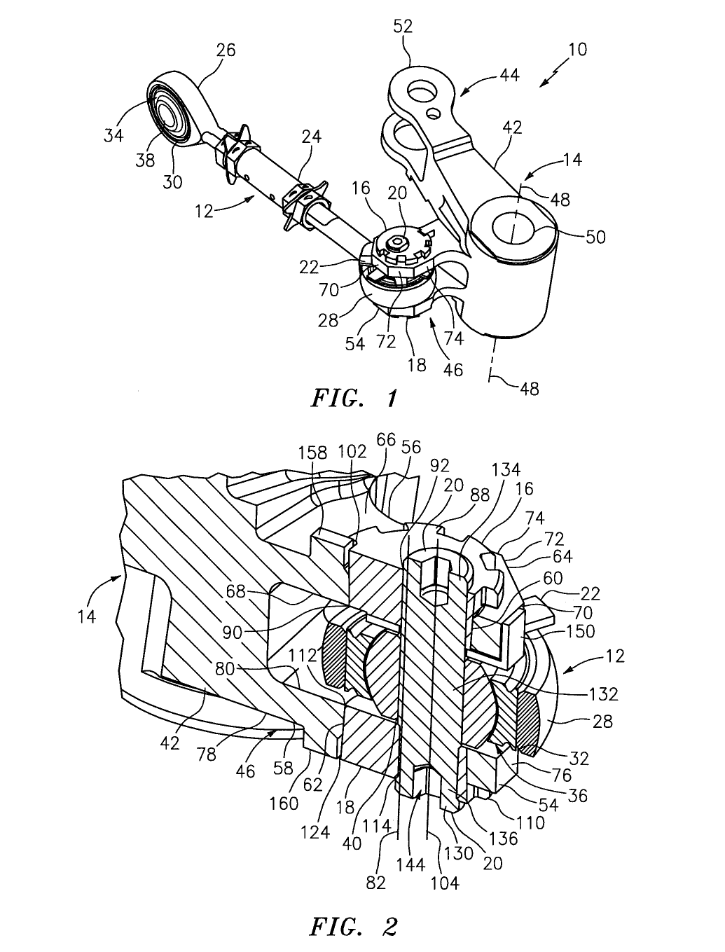

FIG. 1 illustrates an adjustable bell crank system 10 for a gas turbine engine. The bell crank system 10 may include a tie rod 12, a bell crank 14, a first adjustment sleeve 16 (e.g., a first adjustment nut), a second adjustment sleeve 18 (e.g., a second adjustment nut), a clevis pin 20 (e.g., a threaded cylindrical stud) and a tab washer 22.

The tie rod 12 may include an adjustable tie rod shaft 24 connected between a first tie rod tongue 26 and a second tie rod tongue 28. Referring to FIGS. 1 and 2, the first tie rod tongue 26 and/or the second tie rod tongue 28 may each respectively include a pin aperture 30, 32 and a heim joint 34, 36 (e.g., a spherical rod end bearing). The pin aperture 30, 32 extends through the respective tie rod tongue 26, 28, and the respective heim joint 34, 36 is seated in the pin aperture 30, 32. Each heim joint 34, 36 includes a respective pin aperture 38, 40 extending therethrough.

Referring again to FIG. 1, the bell crank 14 may include a bell crank base segment 42 connected between a first clevis 44 and a second clevis 46. The bell crank 14 may pivotally rotate about a rotational axis 48 that extends through a pivot aperture 50 in the bell crank base segment 42. The first clevis 44 extends in a first direction from the bell crank base segment 42 to a first distal end 52. The second clevis 46 extends in a second direction from the bell crank base segment 42 to a second distal end 54. In the embodiment illustrated in FIG. 1, the second direction is substantially perpendicular to the first direction, which provides the bell crank 14 with a substantially L-shaped geometry.

Referring to FIG. 2, the second clevis 46 includes a first support flange 56, a second support flange 58, a first sleeve aperture 60, and a second sleeve aperture 62. The first support flange 56 extends laterally from the bell crank base segment 42 to the second distal end 54. The first support flange 56 includes a first clevis side surface 64 that extends axially between a first outer clevis surface 66 and a first inner clevis surface 68. The first clevis side surface 64 may have a compound geometry with, for example, one or more substantially flat clevis side surface segments (e.g., 70, 72 and 74) arranged around the first sleeve aperture 60. The second support flange 58 extends laterally from the bell crank base segment 42 to the second distal end 54. The second support flange 58 includes a second clevis side surface 76 that extends axially between a second outer clevis surface 78 and a second inner clevis surface 80. The first sleeve aperture 60 extends axially through the first support flange 56 along a first axis 82 between the first outer clevis surface 66 and the first inner clevis surface 68. The second sleeve aperture 62 extends axially through the second support flange 58, for example along the first axis 82, between the second outer clevis surface 78 and the second inner clevis surface 80.

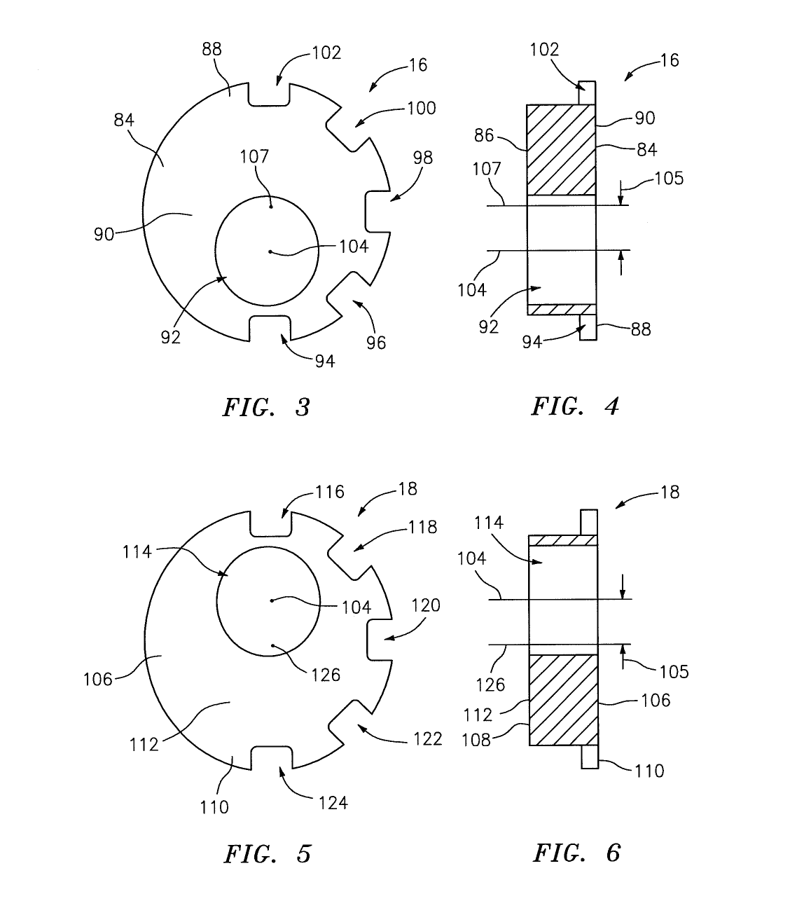

Referring to FIGS. 3 and 4, the first adjustment sleeve 16 extends axially between a first sleeve end 84 and a second sleeve end 86. The first adjustment sleeve 16 may include a first sleeve positioning flange 88 (e.g., a notched annular flange), a (e.g., cylindrical) first sleeve base segment 90, and a threaded (e.g., right-hand-threaded) pin aperture 92. The first sleeve positioning flange 88 extends circumferentially around the first sleeve base segment 90, and may be located adjacent the first sleeve end 84. The first sleeve positioning flange 88 may include one or more first positioning notches 94, 96, 98, 100 and 102 arranged circumferentially around, for example, a portion (e.g., half) of the first sleeve base segment 90. The pin aperture 92 extends axially through the first sleeve base segment 90 along a second axis 104 between the first sleeve end 84 and the second sleeve end 86. The second axis 104 is substantially parallel to and is located a first distance 105 from a center axis 107 (e.g., the first axis 82) of the first sleeve base segment 90. The pin aperture 92 therefore is arranged eccentric to the first sleeve base segment 90 and, thus, also to the first sleeve aperture 60 (see FIG. 2). The pin aperture 92 may also be located adjacent to at least one of the first positioning notches (e.g., first positioning notch 94).

Referring to FIGS. 5 and 6, the second adjustment sleeve 18 extends axially between a first sleeve end 106 and a second sleeve end 108. The second adjustment sleeve 18 may include a second sleeve positioning flange 110 (e.g., a notched annular flange), a (e.g., cylindrical) second sleeve base segment 112, and a threaded (e.g., left-hand-threaded) pin aperture 114. The second sleeve positioning flange 110 extends circumferentially around the second sleeve base segment 112, and may be located adjacent the first sleeve end 106. The second sleeve positioning flange 110 may include one or more second positioning notches 116, 118, 120, 122 and 124 arranged circumferentially around, for example, a portion (e.g., half) of the second sleeve base segment 112. The pin aperture 114 extends axially through the second sleeve base segment 112 along the second axis 104 between the first sleeve end 106 and the second sleeve end 108. The second axis 104 may be located the first distance 105 from a center axis 126 of the second sleeve base segment 112. The pin aperture 114 therefore is arranged eccentric to the second sleeve base segment 112 and, thus, also to the second sleeve aperture 62 (see FIG. 2). The pin aperture 114 may also be located adjacent to at least one of the second positioning notches (e.g., second positioning notch 116).

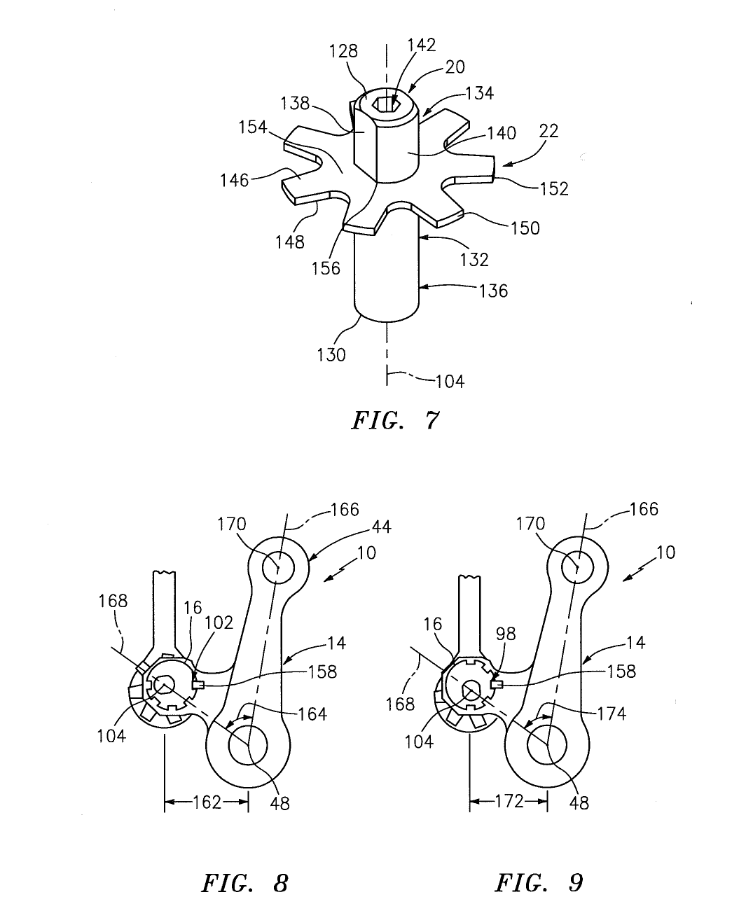

Referring to FIG. 7, the clevis pin 20 extends along the second axis 104 between a first pin end 128 and a second pin end 130. The clevis pin 20 may include an intermediate pin segment 132 connected axially between a threaded (e.g., right-hand-threaded) first pin segment 134 and a threaded (e.g., left-hand-threaded) second pin segment 136. The first pin segment 134 may have a keyed cross-sectional geometry that extends axially from the intermediate pin segment 132 to the first pin end 128. The keyed cross-sectional geometry may include, for example, one or more substantially flat side surface segments (e.g., 138) and one or more threaded arcuate side surface segments (e.g., 140). The second pin segment 136 extends axially from the intermediate pin segment 132 to the second pin end 130. A first keyed (e.g., hexagonal) wrenching aperture 142 may extend axially from the first pin end 128 into the first pin segment 134. Referring to FIG. 2, a second keyed (e.g., hexagonal) wrenching aperture 144 may extend axially from the second pin end 130 into the second pin segment 136.

Referring again to FIG. 7, the tab washer 22 extends axially between a first washer end 146 and a second washer end 148. The tab washer 22 includes one or more tabs (e.g., 150, 152) and a washer base segment 154. The tabs 150 and 152 extend radially from and are located circumferentially around the washer base segment 154. The washer base segment 154 includes a keyway pin aperture 156 that extends along the second axis 104 between the first washer end 146 and the second washer end 148. The first pin segment 134 extends through the keyway pin aperture 156, and the second washer end 148 is positioned adjacent to the intermediate pin segment 132. The keyed cross-sectional geometry of the first pin segment 134 cooperates with the keyway pin aperture 156 such that the tab washer 22 may be rotatably fixed relative to the clevis pin 20.

Referring to FIG. 2, the second tie rod tongue 28 is arranged between the first inner clevis surface 68 and the second inner clevis surface 80. The intermediate pin segment 132 extends through the pin aperture 40. The first pin segment 134 is mated with (e.g., screwed into) the pin aperture 92, and the second pin segment 136 is mated with the pin aperture 114. The first sleeve positioning flange 88 engages (e.g., contacts) the first outer clevis surface 66, and the first sleeve base segment 90 extends into the first sleeve aperture 60. A first protrusion 158 extends from the first outer clevis surface 66 and through a respective one of the first positioning notches (e.g., the first positioning notch 102). The second sleeve positioning flange 110 engages the second outer clevis surface 78, and the second sleeve base segment 112 extends into the second sleeve aperture 62. A second protrusion 160 extends from the second outer clevis surface 78 and through a respective one of the second positioning notches (e.g., the second positioning notch 124). The washer base segment 154 is located adjacent to the first inner clevis surface 68. The tab 150 is bent against the first support flange 56 and cooperates with the clevis side surface segment 70, for example, to prevent the clevis pin 20 from rotating and loosening during system operation.

Referring to FIGS. 8 and 9, the first adjustment sleeve 16 and the second adjustment sleeve 18 (not shown) may be selectively rotated (e.g., together) during assembly (or after installation) to adjust the geometry of the bell crank system 10. Referring to FIG. 8, for example, the first adjustment sleeve 16 may be selectively rotated such that the first protrusion 158 extends through the first positioning notch 102. In this first configuration, the bell crank 14 has a first clevis arm length 162 and a first bell crank angle 164. The term “clevis arm length” refers to a distance that may be measured between the rotational axis 48 and the second axis 104. The term “bell crank angle” refers to an angle that may be measured between a first clevis arm vector 166 and a second clevis arm vector 168. The first clevis arm vector 166 may extend from the rotational axis 48 and through a third axis 170 of the first clevis 44, and the second clevis arm vector 168 may extend from the rotational axis 48 and through the second axis 104. Referring now to FIG. 9, the first adjustment sleeve 16 may alternatively be selectively rotated such that the first protrusion 158 extends through the first positioning notch 98. In this second configuration, the bell crank 14 has a second clevis arm length 172 and a second bell crank angle 174. Referring to FIGS. 8 and 9, the second clevis arm length 172 may be less than the first clevis arm length 162, and the second bell crank angle 174 may be greater than the first bell crank angle 164.

In other embodiments, one or more alternate tabs may be bent against the first support flange to prevent the clevis pin from rotating and loosening during system operation.

While various embodiments of the present invention have been disclosed, it will be apparent to those of ordinary skill in the art that many more embodiments and implementations are possible within the scope of the invention. Accordingly, the present invention is not to be restricted except in light of the attached claims and their equivalents.

Listing of the claims:

1. An adjustable clevis assembly, comprising:
a clevis comprising a first support flange extending from a base segment, a second support flange extending from the base segment, a first sleeve aperture extending through the first support flange, and a second sleeve aperture extending through the second support flange;
a first adjustment sleeve seated in the first sleeve aperture, and comprising a threaded first pin aperture that extends through the first adjustment sleeve and that is eccentric relative to the first sleeve aperture;
a second adjustment sleeve seated in the second sleeve aperture, and comprising a threaded second pin aperture that extends through the second adjustment sleeve and that is eccentric relative to the second sleeve aperture;
a tongue arranged between the first support flange and the second support flange, and comprising a third pin aperture; and
a clevis pin comprising an intermediate pin segment connected axially between a threaded first pin segment and a threaded second pin segment, wherein the intermediate pin segment extends through the third pin aperture, the first pin segment is mated with the first pin aperture, the second pin segment is mated with the second pin aperture.

2. The assembly of claim 1, wherein
the first sleeve aperture extends through the first support flange between an outer clevis surface and an inner clevis surface;
the first adjustment sleeve comprises a sleeve positioning flange that extends around a sleeve base segment; and
the sleeve positioning flange engages the outer clevis surface and the sleeve base segment extends into the first sleeve aperture.

3. The assembly of claim 2, wherein the sleeve positioning flange comprises a plurality of positioning notches located around the sleeve base segment; and a protrusion extends from the outer clevis surface and through one of the plurality of positioning notches.

4. The assembly of claim 3, wherein
the second sleeve aperture extends through the second support flange between a second outer clevis surface and a second inner clevis surface;
the second adjustment sleeve comprises a second sleeve positioning flange that extends around a second sleeve base segment; and
the second sleeve positioning flange engages the second outer clevis surface and the second sleeve base segment extends into the second sleeve aperture.

5. The assembly of claim 4, wherein
the second sleeve positioning flange comprises a plurality of second positioning notches located around the second sleeve base segment; and
a second protrusion extends from the second outer clevis surface and through one of the plurality of second positioning notches.

6. (canceled)

7. The assembly of claim 1, further comprising a tab washer rotatably fixed onto the clevis pin, the tab washer comprising a plurality of tabs extending radially from a washer base segment, wherein the first sleeve aperture extends through the first support flange between an outer clevis surface and an inner clevis surface, and wherein the washer base segment is adjacent to the inner clevis surface, and a first of the plurality of tabs is configured adjacent to a substantially flat clevis side surface segment extending between the outer clevis surface and the inner clevis surface.

8. The assembly of claim 7, wherein the first pin segment comprises a keyed cross-sectional geometry that cooperates with and extends through a keyway pin aperture in the washer base segment.

9. The assembly of claim 1, wherein the clevis pin extends axially between a first pin end and a second pin end, and a keyed wrenching aperture extends axially into the first pin end.

10. The assembly of claim 1, wherein a heim joint connects the clevis pin to the tongue.

11. An adjustable bell crank system, comprising:
a bell crank comprising a first support flange extending from a bell crank base segment, a second support flange extending from the bell crank base segment, a first sleeve aperture extending through the first support flange along a first axis, and a second sleeve aperture extending through the second support flange along the first axis;
a first adjustment sleeve mated with the first sleeve aperture, and comprising a threaded first pin aperture that extends through the first adjustment sleeve along a second axis, wherein the first pin aperture is eccentric relative to the first sleeve aperture;
a second adjustment sleeve mated with the second sleeve aperture, and comprising a second pin aperture that extends through the second adjustment sleeve along the second axis;
a tie rod tongue arranged between the first support flange and the second support flange, the tie rod tongue comprising a third pin aperture; and
a clevis pin extending through the second pin aperture and the third pin aperture, and comprising a threaded first pin segment mated with the first pin aperture.

12. The system of claim 11, wherein
the first sleeve aperture extends through the first support flange between an outer clevis surface and an inner clevis surface;
the first adjustment sleeve comprises a sleeve positioning flange that extends around a sleeve base segment; and
the sleeve positioning flange engages the outer clevis surface and the sleeve base segment extends into the first sleeve aperture.

13. The system of claim 12, wherein
the sleeve positioning flange comprises a plurality of positioning notches located around the sleeve base segment; and
a protrusion extends from the outer clevis surface and through one of the plurality of positioning notches.

14. The system of claim 13, wherein
the second sleeve aperture extends through the second support flange between a second outer clevis surface and a second inner clevis surface;
the second adjustment sleeve comprises a second sleeve positioning flange that extends around a second sleeve base segment; and
the second sleeve positioning flange engages the second outer clevis surface and the second sleeve base segment extends into the second sleeve aperture.

15. The system of claim 14, wherein
the second sleeve positioning flange comprises a plurality of second positioning notches located around the second sleeve base segment; and
a second protrusion extends from the second outer clevis surface and through one of the plurality of second positioning notches.

16. The system of claim 11, wherein
the second pin aperture comprises a threaded second pin aperture;
the clevis pin comprises an intermediate pin segment connected axially between the first pin segment and a threaded second pin segment; and
the second pin segment is mated with the second pin aperture.

17. The system of claim 16, further comprising a tab washer rotatably fixed onto the clevis pin, the tab washer comprising a plurality of tabs extending radially from a washer base segment, wherein the first sleeve aperture extends through the first support flange between an outer clevis surface and an inner clevis surface, and wherein the washer base segment is adjacent to the inner clevis surface, and a first of the plurality of tabs is configured adjacent to a substantially flat clevis side surface segment extending between the outer clevis surface and the inner clevis surface.

18. The system of claim 17, wherein the first pin segment comprises a keyed cross-sectional geometry that cooperates with and extends through a keyway pin aperture in the washer base segment.

19. The system of claim 16, wherein the clevis pin extends axially between a first pin end and a second pin end, and a keyed wrenching aperture extends axially into the first pin end.

20. The system of claim 11, wherein a heim joint connects the clevis pin to the tie rod tongue.

21. An adjustable bell crank system, comprising:
a bell crank including a first support flange extending from a base segment, a second support flange extending from the base segment, a first sleeve aperture extending through the first support flange along a first axis, and a second sleeve aperture extending through the second support flange along the first axis, wherein the first support flange includes a protrusion;
a first adjustment sleeve seated in the first sleeve aperture, and including a first pin aperture and an annular sleeve positioning flange, wherein the first pin aperture extends through the first adjustment sleeve along a second axis that is eccentric relative to the first axis, and the sleeve positioning flange includes a plurality of positioning notches through one of which the protrusion extends;
a second adjustment sleeve seated in the second sleeve aperture, and including a second pin aperture that extends through the second adjustment sleeve along the second axis;
a tongue arranged between the first support flange and the second support flange, and comprising a third pin aperture; and
a clevis pin extending through the first pin aperture, the second pin aperture and the third pin aperture.
